(19) United States
(12) Patent Application Publication
(10) Pub. No.: US 2004/0191367 A1
(43) Pub. Date: Sep. 30, 2004

(54) Food material depositor

(76) Inventor: Raymond Gwilym Dacey, Peterborough (GB)

Correspondence Address: John P White, Cooper & Dunham, 1185 Avenue of the Americas, New York, NY, 10036, US

(21) Appl. No.: 10/473,956

(22) PCT Filed: Apr. 17, 2002
(86) PCT No.: PCT/GB02/01693

(30) Foreign Application Priority Data
Apr. 17, 2001 (GB) 0109310.3

(51) Int. Cl. A23G 1/00

(52) U.S. Cl. 426/103

(57) ABSTRACT

A method of depositing a slug of striped food material comprises sucking a plurality of independent flows of different viscous fluid food (different in colour and/or composition) material into a cylinder (7) of a depositor assembly through respective circumferentially-spaced inlets (16) to the cylinder, preventing reverse flow through said inlets, and then urging the resulting charge of material in the cylinder out of the cylinder through a common outlet (9) so as to extrude the charge into a slug. A plurality of supply passages (11, 12, 13, 14) for the different viscous fluid food material connects respective reservoirs (2, 3, 4, 5) for the food materials to the respective cylinder inlet ports (16), a piston (15) being reciprocable in the cylinder, and piston drive means reciprocating the piston. An outlet valve (10′) controls flow through the outlet port (9), and inlet valve means (15′) controls flow through the inlet ports. The outlet valve can be a one-way valve (10′), and the inlet valve means can be constituted by an edge (15′) on the piston (15) which is so arranged as to uncover the inlet ports (16) as the piston approaches a fully retracted position. Some blending of the adjacent streams where they contact one another in the cylinder can produce intermediate stripes of material in the deposited slug.

This invention relates to a depositor suitable for use in depositing a viscous fluid food material, particularly, but not exclusively, liquid candy.

It is known to create a multi-layered food product by bringing together in a manifold streams of different food material, the manifold having a single outlet through which the resulting combined stream of material flows.

The present invention stems from some work to produce a striped candy product by use of a depositor.

A known depositor for producing a striped candy product utilises four pumps for respectively pumping different candies from four hoppers to a combiner nozzle assembly in which the four streams of candy are brought together. Since the depositor requires a separate pump for each hopper, and the pumps have to be operated together, the overall assembly is relatively complicated to maintain and to clean for product changes.

According to one aspect of the invention a method of depositing a slug of striped food material comprises sucking a plurality of independent flows of different viscous fluid food material (different in colour and/or composition) into a cylinder through respective circumferentially-spaced inlets to the cylinder, preventing reverse flow through said inlets, and then urging the resulting charge of material in the cylinder out of the cylinder though a common outlet so as to extrude the charge into a slug.

According to a second aspect of the invention a depositor comprises a cylinder provided with a cylinder outlet port and with a plurality of circumferentially-spaced cylinder inlet ports, a plurality of supply passages for different viscous fluid food material (different in colour and/or composition) connecting respective reservoirs for the food materials to the respective cylinder inlet ports, a piston reciprocable in the cylinder, and piston drive means for reciprocating the piston, an outlet valve controlling flow through the outlet port, and inlet valve means controlling flow through the inlet ports.

Preferably the arrangement is such that in use the piston is retractable away from said outlet, with said outlet valve closed, to create a vacuum in said cylinder, and then said inlet valve means is opened to allow streams of the food material to be sucked into the cylinder through said inlet ports, and then the piston is movable forwardly to expel the charge of material in the cylinder through the cylinder outlet after closing of said inlet valve means.

The outlet valve is preferably a one-way valve, and preferably comprises a one-way ball-valve member.

The inlet valve means is preferably constituted by an edge on the piston which uncovers the inlet ports as the piston approaches a fully retracted position, the inlet ports being disposed in the side wall of the cylinder.

The reservoirs are preferably in the form of hoppers, and the supply passages lead from the lower ends of the respective hoppers.

In a preferred embodiment the cylinder inlet ports are just below the level of the lower ends of the hoppers, and conveniently the passages are provided in a plate which defines the base of the hoppers, the cylinder projecting downwardly below the base plate to define the cylinder space which receives the charge of material.

The cylinder is preferably a cylinder sleeve which is received in a hole in said base plate, the lower ends of the passages terminating in openings into the wall of said hole, in substantial register with the inlet ports in the cylinder sleeve.

The upper part of the cylinder is conveniently housed in one of the hoppers.

The hoppers are preferably arranged in a row, as viewed in plan, but could be disposed angularly about the cylinder.

According to a third aspect of the invention we provide a deposited slug of striped candy made up from a plurality of streams of liquid candy of different colours, intermediate stripes of different colours in the deposited slug having been produced by blending of the material in the regions of contact between adjacent streams in a pump cylinder into which the candy streams flow prior to being expelled from the cylinder.

A depositor assembly in accordance with the invention, and suitable for depositing striped candy, will now be described, by way of example only, with reference to the accompanying drawings in which:

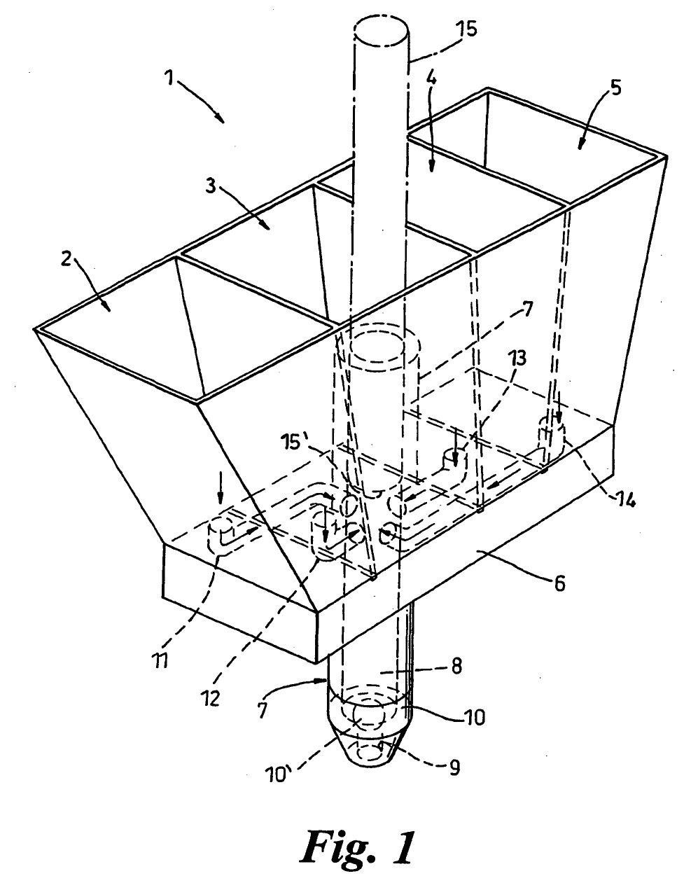

FIG. 1 is a schematic perspective view of the depositor, with the piston shown in broken outline in a fully retracted position; and

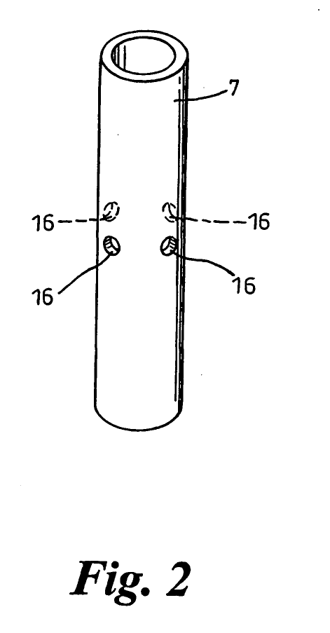

FIG. 2 is a perspective view of the cylinder of the depositor assembly of FIG. 1.

The depositor 1 comprises four open-topped hoppers 2, 3, 4, 5 arranged in a row, as viewed in plan, and tapering downwards to a common, horizontal base plate 6. Arranging the hoppers in a row facilitates the mounting of similar depositors in side-by-side banks.

A cylinder 7 in the form of a cylinder sleeve extends through a circular hole in base plate 6, through the base of the hopper 3, the cylinder being an interference fit in said hole. Approximately half of the length of the cylinder sleeve is disposed below base plate 6 to define a cylinder space to receive a charge of viscous candy.

A central outlet port 9 is provided in the lower end of the cylinder which is in the form of a depositor nozzle 10, the nozzle incorporating a one-way ball valve 10′ which permits liquid candy to be expelled from the cylinder space 8 through the outlet port 9 but does not permit air to be sucked into the cylinder through port 9. The skilled technician will be familiar with suitable ball valves for this purpose.

Base plate 6 is drilled with four supply passages 11, 12, 13, 14 which are each of generally L-shape comprising a vertical limb which breaks through the upper surface of base plate 6 to provide respective hopper outlets, and a generally horizontal limb which terminates in a respective opening defined in the bore wall of said hole which receives the cylinder sleeve 7, the four openings being in register with respective circumferentially-spaced inlet ports 16, FIG. 2, that are provided in the cylinder sleeve, at positions disposed substantially 90° apart from one another.

A vertically movable piston 15 is reciprocable by a suitable piston drive means, not shown, such as a motor-driven crank.

In operation, the hoppers 2, 3, 4 and 5 are supplied with candy which will usually be of a similar composition, whereby the viscosity characteristics will be similar, but of different colour in the different hoppers.

After priming of the cylinder, the operation is as follows:

The piston can be considered initially to be in a fully advanced position, that is with its lower end close to the lower end 10 of the cylinder. The piston is then raised and, since the ball valve 10′ closes, a vacuum is developed in cylinder space 8 as the piston is retracted upwards.

Initially, the inlet ports are closed by the sidewall of the piston, but just before the piston reaches a fully-retracted, upward position, the inlet ports are uncovered by the front (lower) edge 15 of the piston 15. The vacuum created in space 8 causes candy to be sucked into the cylinder space 8 from the four hoppers 2, 3, 4 and 5 by way of the respective supply passages 11, 12, 13 and 14, and inlets 16 The flow resistances of those passages 11 to 14 can be made to be substantially the same if desired, such that substantially equal quantities of the different colours of candy are sucked into the cylinder space 8.

Since the differently coloured candies enter space at positions 90° spaced-apart, this results in a uniformly-striped charge of candy in the cylinder space 8.

On forward movement of the piston, this charge of striped candy is then extruded in passing through nozzle 9 to produce a striped slug of candy, which is generally deposited into a mould carried by a conveyor.

Depending upon the settings of the machine (timing and position of the mould cavity relative to the deposit nozzle) the stripes may be straight or they may be swirled in the deposited slug of material lying in the mould cavity.

Depending upon the compositions of the coloured candies and on the temperatures of the candy supplies, some blending of colours may take place in the cylinder space 8 between the differently-coloured candy streams, leading to the creation of intermediate bands of other colours, thereby giving the appearance of more than four bands of colour in the final product. For example, yellow and blue streams of candy may blend together at the their edges to produce an intermediate band of green candy.

It will be appreciated that the reason why some blending of adjacent streams can take place, when the conditions are chosen to promote this, is the relatively long time that the streams are in contact with one another, in space 8, before they issue from the nozzle outlet 9, as compared with known depositors in which the different candy streams are brought together in a combiner nozzle.

1. A method of depositing a slug of striped food material comprises sucking a plurality of independent flows of different viscous fluid food material into a cylinder (7) through respective circumferentially-spaced inlets to the cylinder, preventing reverse flow through said inlets, and then urging the resulting charge of material in the cylinder out of the cylinder though a common outlet so as to extrude the charge into a slug.

2. The method of claim 1 in which the food material is sucked into the cylinder (7) by displacement of a piston (15) within the cylinder.

3. The method of claim 2 in which on retraction of the piston away from said outlet (9), said outlet valve (10′) is closed, to create a vacuum in said cylinder, and then said inlet valve means (15′, 16) is opened to allow streams of the food material to be sucked into the cylinder through said inlet ports (16), and then the piston is movable forwardly to expel the charge of material in the cylinder through the cylinder outlet after closing of said inlet valve means.

4. The method of claim 3 in which reverse flow through said inlets is prevented by forward displacement of the piston to a position in which the piston covers said inlets.

5. A depositor comprising a cylinder (7) provided with a cylinder outlet port (9) and with a plurality of circumferentially-spaced cylinder inlet ports (16), a plurality of supply passages (11, 12, 13, 14) for different viscous fluid food material and connecting respective reservoirs (2, 3, 4, 5) for the food materials to the respective cylinder inlet ports (16), a piston (15) reciprocable in the cylinder, and piston drive means for reciprocating the piston, an outlet valve (10′) controlling flow through the outlet port (9), and inlet valve means (15′) controlling flow through the inlet ports.

6. A depositor as claimed in claim 5 in which the outlet valve is a one-way valve (10′).

7. A depositor as claimed in claim 5 or claim 6 in which the inlet valve means is constituted by an edge (15) on the piston (15) which is so arranged as to uncover the inlet ports (16) as the piston approaches a fully retracted position, the inlet ports being disposed in the side wall of the cylinder.

8. A depositor as claimed in any one of the claims 5 to 7 in which the reservoirs are in the form of hoppers (2, 3, 4, 5), and the supply passages lead from the lower ends of the respective hoppers.

9. A depositor as claimed in claim 8 in which the cylinder inlet ports (16) are just below the level of the lower ends of the hoppers, and the passages (11, 12, 13, 14) are provided in a plate (6) which defines the base of the hoppers, the cylinder projecting downwardly below the base plate to define the cylinder space (8) which receives the charge of material.

10. A depositor as claimed in claim 9 in which the cylinder is a cylinder sleeve which is received in a hole in said base plate, the lower ends of the passages terminating in openings into the wall of said hole, in substantial register with the inlet ports in the cylinder sleeve.

11. A depositor as claimed in claim any one of claims 8 to 10 in which the upper part of the cylinder is conveniently housed in one of the hoppers.

12. A depositor as claimed in any one of claims 8 to 11 in which the hoppers are arranged in a row, as viewed in plan.

13. A deposited slug of striped candy made up from a plurality of streams of liquid candy of different colours, intermediate stripes of different colours in the deposited slug having been produced by blending of the material in the regions of contact between adjacent streams in a pump cylinder into which the candy streams flow prior to being expelled from the cylinder.
